(19) United States
(12) Patent Application Publication
(10) Pub. No.: US 2013/0337814 A1
(43) Pub. Date: Dec. 19, 2013

(54) LOAD BALANCING IN A NETWORK AND BETWEEN NETWORKS

(71) Applicants: Curt WONG, Sammamish, WA (US); Manivannan THYAGARAJAN, Coppell, TX (US); Devaki CHANDRAMOULI, Plano, TX (US)

(72) Inventors: Curt WONG, Sammamish, WA (US); Manivannan THYAGARAJAN, Coppell, TX (US); Devaki CHANDRAMOULI, Plano, TX (US)

(73) Assignee: Nokia Siemens Networks Oy

(21) Appl. No.: 13/495,397

(22) Filed: Jun. 13, 2012

(51) Int. Cl. H04W 36/08

(52) U.S. Cl. 455/438

(57) ABSTRACT

The specification and drawings present a new method, apparatus and software related product (e.g., a computer readable memory) for load balancing in a network (e.g., LTE wireless network) and between networks based on reselection priority and/or a level of congestion. The embodiments of the invention describe different options to move the UE to another cell which may be in the same or in a different RAT, to avoid congestion and/or overloading of the network. This will help to avoid subsequent RRC connection reject messages being sent to the UE from the congested cell.

### TECHNICAL FIELD

The exemplary and non-limiting embodiments of this invention relate generally to wireless communications and more specifically to load balancing in a network and between networks based on reselection priority and congestion.

### BACKGROUND ART

The following abbreviations that may be found in the specification and/or the drawing figures are defined as follows:
3GPP third generation partnership project
AN access node (access point)
CDMA code division multiple access
DL downlink
EDGE enhanced data rates for GSM (global) evolution EPC
eHRPD enhanced (evolved) CDMA2000 high rate packet data
EPC evolved packet core
EPS evolved packet system
E-UTRA evolved universal terrestrial radio access
eNB or eNodeB evolved node B /base station in an E-UTRAN system
GERAN GSM EDGE radio access network
GSM global system for mobile communication
GPRS general packet radio services
E-UTRAN evolved UTRAN (LTE)
IMS IP multimedia sybsystem
HRPD CDMA2000 high rate packet data
HSGW HRPD serving gateway
HSS home subscriber server
IP interne protocol
LTE long term evolution
LTE-A long term evolution advanced
MME mobility management entity
O&M operation and maintenance
PCRF policy and charging rule function
PDN-GW packet data network gateway
PRB physical resource block
RRC radio resource control
RAN radio access network
RAT radio access technology
SAE system architecture evolution
S1-AP S1 application protocol
SGW serving gateway
SIB system information block
UE user equipment (e.g. mobile terminal)
UL uplink
UMTS universal mobile telecommunications system
UTRAN universal terrestrial radio access network
WiFi a synonym of WLAN
WiMax worldwide interoperability for microwave access
WLAN wireless local area network

EPS allows non 3GPP RAT interworking for example with eHRPD used in CDMA2000 networks using architecture defined in 3GGP TS 23.402 (see FIG. 1).

Operator with LTE and non 3GPP RATs requires a way for load balancing between its LTE and non 3GPP RATs (e.g., eHPRD radio access) networks. The following reason is used for justification.

Usually E-UTRAN's priority is higher than eHRPD's priority, so that most users will camp on E-UTRAN network in overlay area (E-UTRAN and eHRPD) based on the current specification. Therefore, in an idle state, the user will reselect to a network based on priority (provided by the network/operator). So in the overlay area (E-UTRAN and eHRPD) UEs will congregate in the E-UTRAN network. Even in a situation when the E-UTRAN is overloaded and the eHRPD is free, the UE will reselect to a cell in the E-UTRAN network, e.g., when it is in an idle state. As a result, the E-UTRAN may be very congested while the eHRPD may not be used adequately.

In other words, the idle mode RAT priority selection is somewhat semi-static today. The eNB broadcasts parameters influencing the cell reselection criteria in SIB8 on LTE side, and the UE uses this for RAT selection during the idle mode of operation. In most cases, an operator sets LTE with higher priority which causes most of the UE(s) to camp on to it, which raises the problem described above.

### SUMMARY

According to a first aspect of the invention, a method comprising: determining in at least one access node utilizing a first radio access technology a reselection priority based at least on whether at least one cell supported by the at least one access node is overloaded or not overloaded; and broadcasting by the at least one access node to at least one user equipment a reselection priority message before the at least one user equipment attempted to reselect to the at least one cell.

According to a second aspect of the invention, a method comprising: receiving by a user equipment from each access node of a plurality of access nodes utilizing a first radio access technology a reselection priority message which at least specifies whether a cell supported by the each access node has a high or a low reselection priority; and reselecting by the user equipment a further cell based on the received reselection priority messages from the plurality of the access nodes.

According to a third aspect of the invention, an apparatus comprising: at least one processor and a memory storing a set of computer instructions, in which the processor and the memory storing the computer instructions are configured to cause the apparatus to: determine in at least one access node utilizing a first radio access technology a reselection priority based at least on whether at least one cell supported by the at least one access node is overloaded or not overloaded; and broadcast to at least one user equipment a reselection priority message before the at least one user equipment attempted to reselect to the at least one cell.

According to a fourth aspect of the invention, an apparatus comprising: at least one processor and a memory storing a set of computer instructions, in which the processor and the memory storing the computer instructions are configured to cause the apparatus to: receive from each access node of a plurality of access nodes utilizing a first radio access technology a reselection priority message which at least specifies whether a cell supported by the each access node has a high or a low reselection priority; and reselect to a further cell based on the received reselection priority messages from the plurality of the access nodes.

### BRIEF DESCRIPTION OF THE DRAWINGS

For a better understanding of the nature and objects of the present invention, reference is made to the following detailed description taken in conjunction with the following drawings, in which:

FIG. 1 reproduces FIG. 9.1.1-1 of 3GPP TS 23.402: “Architecture for optimized handovers between E-UTRAN access and CDMA2000 HRPD access (non-roaming case)”;

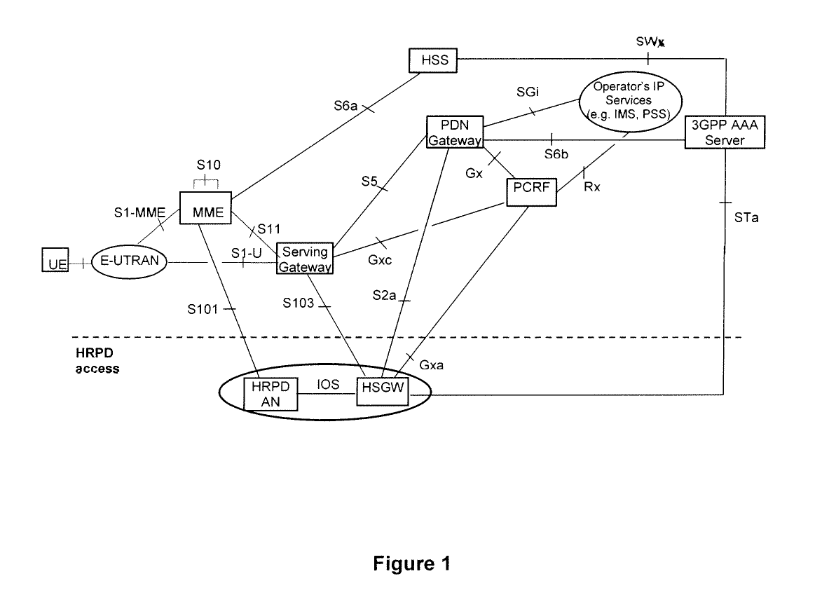

FIG. 2 is a flow chart demonstrating implementation of exemplary embodiments of the invention by an access node (eNB); and

FIG. 3 is a flow chart demonstrating implementation of exemplary embodiments of the invention by a UE; and

FIG. 4 is a block diagram of wireless devices for practicing exemplary embodiments of the invention.

### DETAILED DESCRIPTION

Recently, CT1 and RAN2 have discussed a solution where the UE will try to access LTE and if it gets RRC connection reject 5 times then it is free to reselect to other RAT (3GPP TS 36.331). The drawback of this approach is that the UE will have to wait for the connection reject 5 times (including the back-off period) before it can re-select to other non 3GPP RATs.

A new method, apparatus, and software related product (e.g., a computer readable memory) are presented for load balancing in a network (e.g., LTE wireless network) and between networks based on reselection priority and/or a level of congestion. The embodiments of the invention describe different options to move the UE to another cell which may be in the same or in a different RAT, to avoid congestion and/or overloading of the network. This will help to avoid subsequent RRC connection reject messages being sent to the UE from the congested cell.

The exemplary embodiments of this invention discuss how load sharing can be performed within one RAT (e.g., in LTE network) and/or between different (e.g., two) RATs (e.g., the LTE and CDMA2000). Although this eHPRD RAT can be used herein as an example of the non 3GPP RAT, the same principle can be applied to other 3GPP and non-3GPP RATs as well (e.g., GERAN/UTRAN, Wi-FI, WiMax, etc).

For example, in one embodiment, an access node (which is associated for the purpose of this invention with eNB, base station, access point and the like) utilizing a first RAT (e.g., in LTE network) may determine a reselection priority based at least on whether a cell supported by the access node is overloaded or not overloaded. Then this access node may broadcast to UEs or to at least one UE (each UE may be in idle mode or not in the idle mode) in the area a reselection priority message before the at least one user equipment attempted to reselect to this cell.

If the reselection priority message indicates a high reselection priority for the cell/access node, then the UE may reselect to this cell/access node (e.g., eNB). If, however, the reselection priority message indicates a low reselection priority (e.g., de-prioritizing a frequency or frequency-time resources in general) for the cell/access node, the UE will reselect to a further cell utilizing the first RAT or a further (e.g., second) RAT (e.g., CDMA2000) geographically overlapping with the first RAT, as described herein.

According to a further embodiment, a UE may receive from each access node of a plurality of access nodes utilizing a first RAT (e.g., in LTE network) a broadcast with a reselection priority message which at least specifies whether a cell supported by the each access node has a high or a low reselection priority (i.e., overloaded or not overloaded). Then the UE may reselect to a further cell based on the received reselection priority messages from the plurality of the access nodes.

For example, the UE may reselect to the further cell which utilizes the first RAT (e.g., LTE) and has high reselection priority according to the corresponding received reselection priority message. On the other hand, if all received reselection priority messages from the plurality of access nodes utilizing the RAT indicate a low reselection priority, the UE then will reselect to a further cell utilizing a second RAT (e.g., CDMA2000) geographically overlapping with the first RAT. This reselection algorithm assumes that the second RAT has a lower “long term” reselection priority than the first RAT which can be set up, for example, by a system operator having control over both RATs (e.g., the LTE and CDMA2000).

According to another embodiment, this relative priority between different geographically overlapping RATs and/or a group of cells and/or even for one cell may be changed dynamically and/or temporarily by the operator (e.g., via O&M) or by a core network (e.g., by MME in the LTE network) to get a relief for an overloaded network/cells/cell, e.g., for a specified period of time. For example, the broadcast message to the UEs sent by the access node (eNB) may comprise an indication to lower the reselection priority of the first RAT at least temporarily, compared to the second RAT, so that the UEs will reselect to a cell in the second RAT.

According to further embodiments, there are a few possible ways (which can be used alone or in combination) to broadcast a message to the UE to help re-select another cell/RAT even before sending a signaling message for reselection to the congested cell/eNB. For including this message in the broadcast message, 3 possible non-limiting options are discussed herein.

When E-UTRAN comprising a plurality of eNBs (or just one eNB) in LTE is overloaded or when E-UTRAN/eNB receives an S1-AP “overload” indication from MME, the E-UTRAN/eNB can:

Option1: dynamically adjust the “CellReselectionPriority” parameters (e.g., between high and low cell reselection priority) in SIB8 (see 3GPP TS 36.331) so that the UE (e.g., the idle UE) will reselect to another RAT (e.g., eHPRD access) or another “non-congested” cell in LTE accordingly, as described herein. The eNB, for example, may adjust the value for the existing cell reselection parameter such that the radio frequency/resource may be de-prioritized (in times of congestion).

Moreover, this option of reusing “CellReselectionPriority” in this dynamic fashion may be used for the existing UEs. This requires eNB to have an internal algorithm to reset SIB8 back to normal operating values such that LTE is again the highest priority after overload condition is subsided. Changing SIB8 will require the UE to re-read the whole SIB8 information.

Option 2: defining a new bit in SIB8 which allows newer UE to temporary reselect to eHPRD access or another RAT (e.g. GERAN, UTRAN) or reselect to another “non-congested” cell in LTE if available in an alternative implementation, as described herein. It can make the eNB implementation simpler as it just needs to turn on/off a bit without changing the CellReselectionPriority. This bit can indicate whether the current cell priority is “low” or current RAT, i.e., LTE priority is “low”. The UE will periodically check this bit in SIB8 and if it indicates current RAT priority is “low”, then it will not select LTE as highest priority RAT. In an alternative implementation, if the bit indicates that the current cell priority is low, then the UE will select another “non-congested” cell in LTE accordingly. In other words, in one implementation this new bit can indicate to the UEs (e.g., idle UEs) that they should lower the LTE access priority (e.g., LTE becomes the lower priority) and use another RAT for selecting/reselecting a cell. This option requires newer UE implementation.

Option 3: changing semantics of an existing SIB8 parameter such that the UE is aware that LTE access priority is set for example to low or high. This requires newer UE implementation. Changing semantics of the current SIB8 means that we do not have to expand the SIB8 to include a new bit as for Option 2.

The above embodiments are only exemplary, so that different options (e.g., different SIBs, bits, semantics) may be used for broadcasting a message to the UE to help re-select another cell/RAT based on loading/overloading conditions.

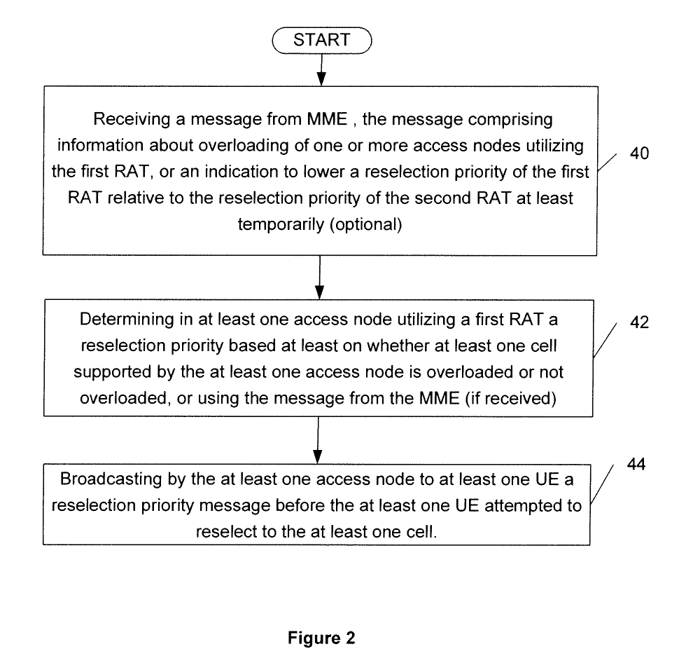

FIG. 2 shows an exemplary flow chart demonstrating implementation of embodiments of the invention by an access node (e.g., eNB). It is noted that the order of steps shown in FIG. 2 is not absolutely required, so in principle, the various steps may be performed out of the illustrated order. Also certain steps may be skipped, different steps may be added or substituted, or selected steps or groups of steps may be performed in a separate application.

In a method according to the exemplary embodiment shown in FIG. 2, in a first step 40, the eNB (at least one access node) utilizing the first RAT (in LTE network) receives a message from MME, the message comprising information about overloading of one or more access nodes (eNBs) utilizing the first RAT or an indication to lower a reselection priority of the first RAT relative to the reselection priority of the second RAT at least temporarily. This step is optional.

In a next step 42, the eNB utilizing the first RAT determines a reselection priority based at least on whether at least one cell supported by the eNB is overloaded or not overloaded. Alternatively, the eNB can use the message from the MME (if received) in step 40 as a reselection priority. In a next step 44, the eNB broadcasts to at least one UE a reselection priority message before the at least one UE attempted to reselect to the at least one cell.

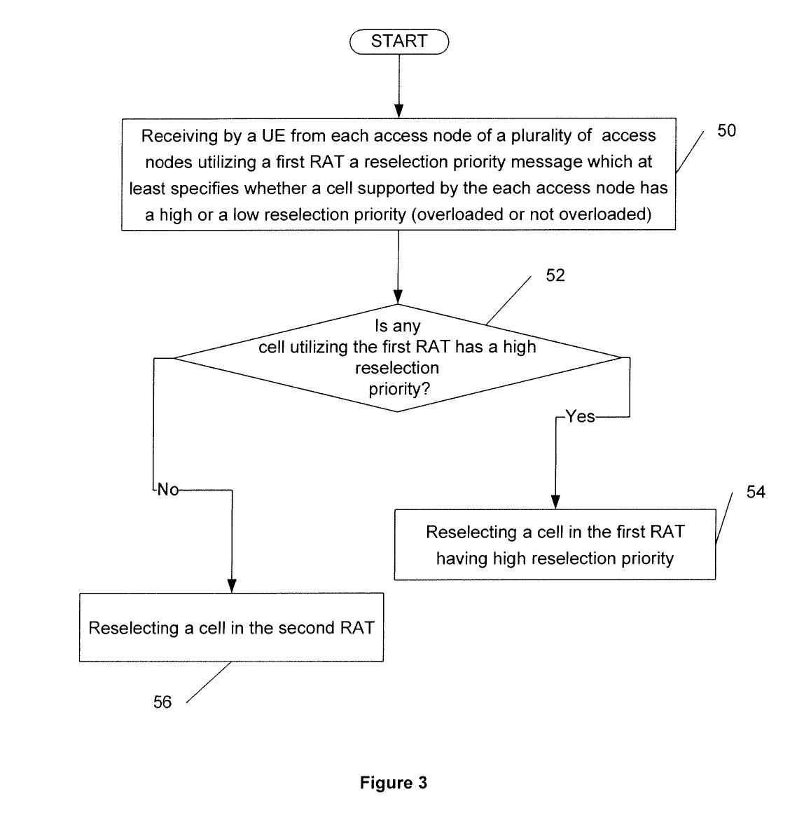

FIG. 3 shows another exemplary flow chart demonstrating implementation of embodiments of the invention by a UE. It is noted that the order of steps shown in FIG. 3 is not absolutely required, so in principle, the various steps may be performed out of the illustrated order. Also certain steps may be skipped, different steps may be added or substituted, or selected steps or groups of steps may be performed in a separate application.

In a method according to the exemplary embodiment shown in FIG. 3, in a first step 50, the UE receives from each access node (e.g., eNB) of a plurality of access nodes (eNBs in a geographical vicinity) utilizing a first RAT a reselection priority message which at least specifies whether a cell supported by the each access node has a high or a low reselection priority (overloaded or not overloaded).

In a next step 52, it is determined (from the received message) by the UE whether any cell utilizing the first RAT has a high reselection priority. If that is the case, in a next step 54, the UE reselects a cell in the first RAT having the high reselection priority. However, if it is determined that all cells utilizing the first RAT have a low reselection priority (this may be equivalent to a message/command by the MME or by the operator to lower the reselection priority of the first RAT at least temporarily), in a next step 56, the UE reselects a cell in the second RAT.

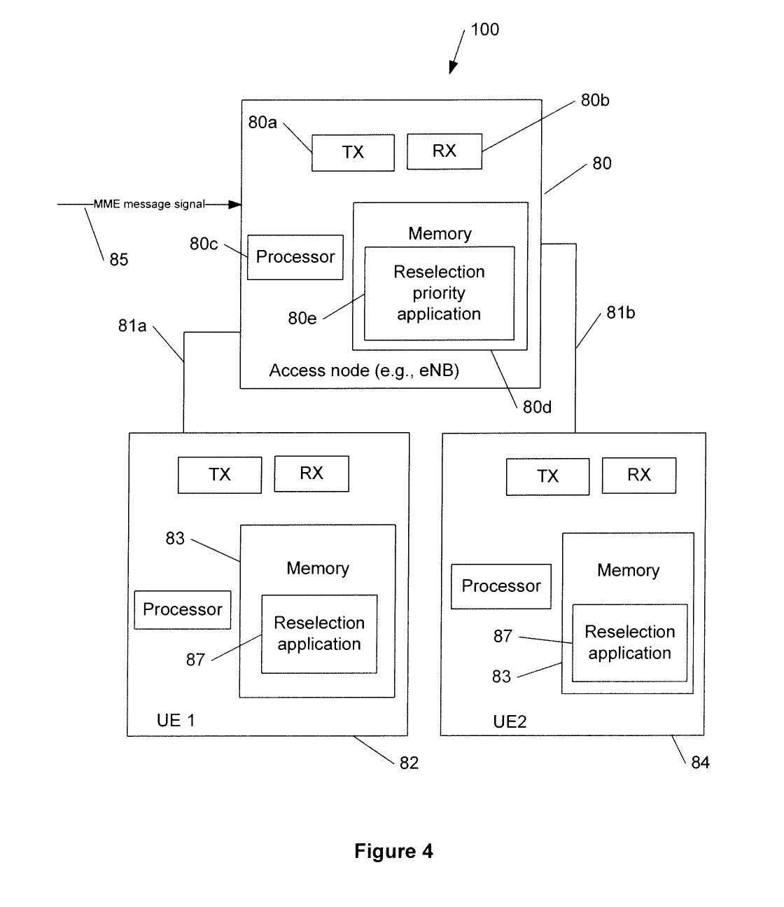

FIG. 4 shows an example of a block diagram demonstrating LTE devices including an access node (e.g., eNB) 80 comprised in a network 100, and UEs 82 and 84 communicating with the eNB 80, according to an embodiment of the invention. FIG. 4 is a simplified block diagram of various electronic devices that are suitable for practicing the exemplary embodiments of this invention, and a specific manner in which components of an electronic device are configured to cause that electronic device to operate.

The eNB 80 may comprise, e.g., at least one transmitter 80a at least one receiver 80b, at least one processor 80c at least one memory 80d and an assigning and reselection priority application module 80e. The transmitter 80a and the receiver 80b may be configured to provide a wireless communication with the UEs 82 and 84 (and others not shown in FIG. 4), e.g., through corresponding links 81a and 81b, according to the embodiment of the invention (e.g., to sent broadcast messages). Also the device 80 can communicate directly or indirectly using a wireless or wired link 85 with a core network (e.g., with MME) as described herein. The transmitter 80a and the receiver 80b may be generally means for transmitting/receiving and may be implemented as a transceiver, or a structural equivalence thereof. It is further noted that the same requirements and considerations are applied to transmitters and receivers of the UEs 82 and 84.

Various embodiments of the at least one memory 80d (e.g., computer readable memory) may include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the processor 80c include but are not limited to general purpose computers, special purpose computers, microprocessors, digital signal processors (DSPs) and multi-core processors. Similar embodiments are applicable to memories and processors in other devices 82 and 84 shown in FIG. 4.

The reselection priority application module 80e may provide various instructions for performing steps 40-44 shown in FIG. 2. The module 80e may be implemented as an application computer program stored in the memory 80d, but in general it may be implemented as software, firmware and/or hardware module or a combination thereof. In particular, in the case of software or firmware, one embodiment may be implemented using a software related product such as a computer readable memory (e.g., non-transitory computer readable memory), computer readable medium or a computer readable storage structure comprising computer readable instructions (e.g., program instructions) using a computer program code (i.e., the software or firmware) thereon to be executed by a computer processor. Furthermore, the module 80e may be implemented as a separate block or may be combined with any other module/block of the device 80, or it may be split into several blocks according to their functionality.

The devices 82 and 84 may have similar components as the eNB 80, as shown in FIG. 4, so that the above discussion about components of the eNB 80 is fully applicable to the components of the UEs 82 and 84.

The reselection application module 87 in UEs 82 and 84 may provide various instructions for performing steps 50-56 shown in FIG. 3. The module 87 may be implemented as an application computer program stored in the memory 83 of UEs 82 and 84, but in general it may be implemented as software, firmware and/or hardware module or a combination thereof. In particular, in the case of software or firmware, one embodiment may be implemented using a software related product such as a computer readable memory (e.g., non-transitory computer readable memory), computer readable medium or a computer readable storage structure comprising computer readable instructions (e.g., program instructions) using a computer program code (i.e., the software or firmware) thereon to be executed by a computer processor. Furthermore, the module 87 may be implemented as a separate block or may be combined with any other module/block of the device 82 or 84, or it may be split into several blocks according to their functionality.

It is noted that various non-limiting embodiments described herein may be used separately, combined or selectively combined for specific applications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the present invention. Numerous modifications and alternative arrangements may be devised by those skilled in the art without departing from the scope of the invention, and the appended claims are intended to cover such modifications and arrangements.

1. A method, comprising:
determining in at least one access node utilizing a first radio access technology a high or low reselection priority based at least on whether at least one cell supported by the at least one access node is respectively overloaded or not overloaded; and
broadcasting by the at least one access node to at least one user equipment a reselection priority message comprising the determined high or low reselection priority before the at least one user equipment attempted to reselect to the at least one cell;
where the reselection priority message comprises a portion of a system information block and comprises a reselection priority parameter having a value that is dynamically adjustable by the access node to inform an idle mode user equipment that the first radio access technology associated with the broadcast system information block is to be de-prioritized for use by the user equipment relative to a second radio access technology so long as the reselection priority parameter indicates a low reselection priority condition.

2. The method of claim 1, wherein when the reselection priority message indicates a low reselection priority for the at least one cell the at least one user equipment will reselect to a further cell utilizing the first radio access technology or to the second radio access technology.

3. The method of claim 1, wherein the second radio access technology is a CDMA2000 high rate packet data access technology and the first radio access technology is a long term evolution access technology.

4. The method of claim 1, wherein the at least one access node is an eNB.

5. (canceled)

6. The method of claim 1, wherein the reselection priority message is comprised in the system information block as a command parameter indicating that the user equipment shall reselect to the further cell utilizing the second radio access technology.

7. The method of claim 1, wherein the determining is defined by a message received from a mobility management entity, the message comprising information about overloading of one or more access nodes, including the at least one access node, utilizing the first radio access technology.

8. The method of claim 1, wherein the determining is defined by a message received from a mobility management entity, the message comprising an indication to at least temporarily lower the reselection priority of the first radio access technology relative to a reselection priority of the second radio access technology.

9. A method, comprising:
receiving by a user equipment from each access node of a plurality of access nodes utilizing a first radio access technology a reselection priority message which at least specifies whether each cell supported by a corresponding access node of the plurality of access nodes has a high or low reselection priority based at least on whether the each cell supported by the corresponding access node is respectively overloaded or not overloaded; and
reselecting by the user equipment a further cell based on the received reselection priority messages from the plurality of the access nodes;
where a reselection priority message is received as a portion of a system information block and comprises a reselection priority parameter having a value that is dynamically adjustable by an access node transmitting the system information block, where the user equipment when in an idle state periodically checks the reselection priority parameter and is informed thereby that the first radio access technology associated with the broadcast system information block is to be de-prioritized for use by the user equipment relative to a second radio access technology so long as the reselection priority parameter indicates a low reselection priority condition.

10. (canceled)

11. (canceled)

12. The method of claim 9, wherein the reselected further cell utilizes the first radio access technology and has a high reselection priority according to the corresponding received reselection priority message.

13. The method of claim 9, wherein, if all received reselection priority messages from the plurality of access nodes utilizing the first radio access technology indicate a low reselection priority, the user equipment utilizes the second radio access technology.

14. The method of claim 9, wherein the second radio access technology has a lower reselection priority than the first radio access technology.

15. (canceled)

16. The method of claim 9, wherein the reselection priority message is comprised in the system information block as a command parameter indicating that the user equipment shall reselect to the further cell utilizing the second radio access technology.

17. The method of claim 9, wherein the second radio access technology is a CDMA2000 high rate packet data access technology and the first radio access technology is a long term evolution access technology.

18. An apparatus comprising:
at least one processor and a memory storing a set of computer instructions, in which the processor and the memory storing the computer instructions are configured to cause the apparatus to:
determine in at least one access node utilizing a first radio access technology a high or low reselection priority based at least on whether at least one cell supported by the at least one access node is respectively overloaded or not overloaded; and
broadcast to at least one user equipment a reselection priority message comprising the determined high or low reselection priority before the at least one user equipment attempted to reselect to the at least one cell;
where the reselection priority message comprises a portion of a system information block and comprises a reselection priority parameter having a value that is dynamically adjustable by the access node to inform an idle mode user equipment that the first radio access technology associated with the broadcast system information block is to be de-prioritized for use by the user equipment relative to a second radio access technology so long as the reselection priority parameter indicates a low reselection priority condition.

19. An apparatus comprising:
at least one processor and a memory storing a set of computer instructions, in which the processor and the memory storing the computer instructions are configured to cause the apparatus to:
receive from each access node of a plurality of access nodes utilizing a first radio access technology a reselection priority message which at least specifies whether each cell supported by a corresponding access node of the plurality of access nodes has a high or low reselection priority based at least on whether the each cell supported by the corresponding access node is respectively overloaded or not overloaded; and
reselect a further cell based on the received reselection priority messages from the plurality of the access nodes;
where a reselection priority message is received as a portion of a system information block and comprises a reselection priority parameter having a value that is dynamically adjustable by an access node transmitting the system information block, where the user equipment when in an idle state periodically checks the reselection priority parameter and is informed thereby that the first radio access technology associated with the broadcast system information block is to be de-prioritized for use by the user equipment relative to a second radio access technology so long as the reselection priority parameter indicates a low reselection priority condition.
